(19) United States
(12) Patent Application Publication
(10) Pub. No.: US 2012/0054734 A1
(43) Pub. Date: Mar. 1, 2012

(54) DEVICE SOFTWARE UPGRADE USING A DYNAMICALLY SIZED PARTITION

(75) Inventors: Jonathan J. Andrews, San Jose, CA (US); Jason Gosnell, San Francisco, CA (US); Dallas B. De Atley, San Francisco, CA (US); Michael Smith, San Francisco, CA (US)

(73) Assignee: APPLE INC., Cupertino, CA (US)

(21) Appl. No.: 12/910,491

(22) Filed: Oct. 22, 2010

Related U.S. Application Data
(60) Provisional application No. 61/378,777, filed on Aug. 31, 2010.

(51) Int. Cl. G06F 9/44

(52) U.S. Cl. 717/171

(57) ABSTRACT

According to one aspect of the invention, a software update image is received by a software updater from a server over a network and stored in an update volume to update one or more system components of a computing device, where the software update image is signed by the server and includes an identifier that uniquely identifies the computing device. A volume manager dynamically resizes the system volume based on a requirement of the one or more system components to be updated without physically relocating data stored in the data volume of the storage device. The software update image is then authenticated including verifying a signature of the image and matching the ID with a unique ID embedded within the device. The one or more system components are installed from the software update image from the update volume into the resized system volume.

### RELATED APPLICATION

This application claims the benefit of U.S. Provisional Patent Application No. 61/378,777, filed Aug. 31, 2010, which is incorporated by reference herein in its entirety.

### FIELD OF THE INVENTION

Embodiments of the invention relate generally to the field of software upgrade in a device; and more particularly, to software upgrade using a dynamically sized partition.

### BACKGROUND

The software industry is constantly rewriting and improving the products it sells. Often, upgraded versions of software are “bug fixes” built to fix some problems that the previous upgrade introduced. Some upgrades add features that users were requesting or that a software developer thought would be desirable. Other upgrades are built to increase a program's compatibility with hardware upgrades or some other piece of software that has already been upgraded.

In some situations, the upgrade is made to system components of a data processing system which normally are stored in a system volume or partition of a storage device. The new upgrade can be installed if the system partition is large enough to store the installed system components. When the system partition is not large enough, it requires a complicated and manual process to modify the system partition; otherwise, the upgrade would not be installed successfully.

### SUMMARY OF THE DESCRIPTION

Methods and apparatus for updating software are described herein. According to one aspect of the invention, a software update image is received by a software updater from a server over a network to update one or more system components of a computing device, where the software update image is signed by the server using a digital signature and the software update image includes an identifier (ID) that uniquely identifies the computing device. The software update image is stored in an update volume specifically created for update purposes in a storage device of the computing device, where the storage device further includes a system volume having system components stored therein and a data volume having user data stored therein. The computing device is then rebooted into the update volume without using the system volume. A volume manager dynamically resizes the system volume based on a requirement of the one or more system components to be updated without physically relocating data stored in the data volume of the computing device. The software update image is then authenticated including verifying the digital signature of the software update image to ensure that the software update image is intended for the computing device and matching the ID of the software update image against a unique (UID) embedded within the computing device. The one or more system components are installed from the software update image from the update volume into the resized system volume.

Other features of the present invention will be apparent from the accompanying drawings and from the detailed description which follows.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating a computing device according to one embodiment of the invention.

FIG. 2 is a flow diagram illustrating a method for software update according to one embodiment of the invention.

FIG. 3 is a block diagram illustrating a chunk mapping mechanism according to one embodiment of the invention.

FIG. 4 is a block diagram illustrating a chunk map entry according to one embodiment of the invention.

FIG. 5 is a flow diagram illustrating a method resizing a partition according to one embodiment of the invention.

FIG. 6 shows an example of a data processing system which may be used with one embodiment of the present invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, a volume manager is utilized to manage at least a system volume of a storage device. When a software update is received, for example, from a server such as an authorization or trusted server), the volume manager is configured to examine requirements of the software update. The volume manager may dynamically resize the system volume without user intervention, such that the resized system volume is suitable to install the software update. For example, because of the ongoing software upgrade, the operating system may become larger and larger and the system volume that stores the operating system may no longer be sufficiently large enough to contain the new upgrade. In this situation, the volume manager may dynamically increase (e.g., grow) the size of the system volume by claiming certain spaces of a data volume (e.g., the space that have not been used). In one embodiment, such modifications of the system volume and data volume are performed by the volume manager without copying and/or moving data stored in the data volume. Furthermore, such modifications may be performed transparently without user interaction or knowledge. Similarly, if the new software utilizes a lesser space than the current system volume, the volume manager may also dynamically reduce (e.g., shrink) the size of the system volume, for example, by giving some spaces back to the data volume for other usages.

The software update may be signed by the server using a digital certificate and include an ID that uniquely identifies the computing device. The digital certificate of the software update can be verified by the computing device to ensure that the software update is received from a trusted server. In addition, the computing device may match the ID extracted from the software update with a unique ID (UID) of the computing device to ensure that the software update is intended for the computing device. The UID may be embedded and/or hardwired within the computing device and as a result, the UID cannot be altered easily. Further, certain portion of the software update may be encrypted by a key that is derived from the UID of the computing device. As a result, only the intended computing device is able to authenticate and/or decrypt the software components from the software update. Furthermore, each software component may also be signed using a chain of certificates (e.g., X.509 chain of certificates). A lower level component or an early loaded component may authenticate a higher level component or subsequently loaded component using the chain of certificates.

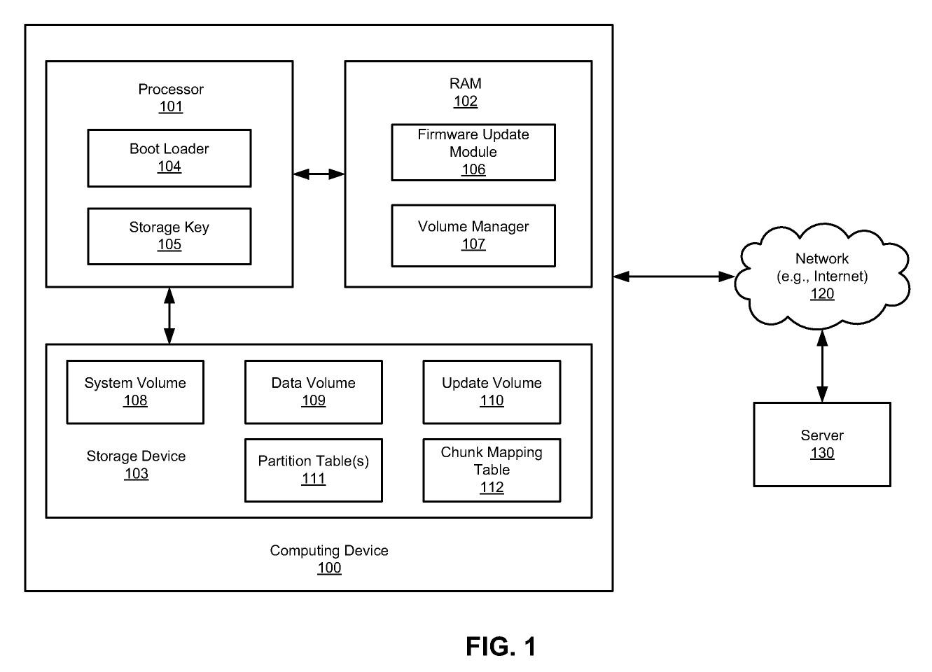

FIG. 1 is a block diagram illustrating a computing device according to one embodiment of the invention. Device 100 may represent any kind of computing or electronic devices or data processing systems. Device 100 may be a portable device, such as portable wireless communication handsets, palmtops, personal digital assistants (PDAs), pocket personal computers (PCs), portable gaming systems, media players, and a combination thereof. For example, device 100 may represent a Smartphone such as an iPhone™ from Apple Inc. of Cupertino, Calif. Alternatively, device 100 may represent a tablet PC such as an iPad™ from Apple Inc. Further, device 100 may represent a desktop or a workstation (e.g., iMac™ from Apple Inc.), a set-top box device, or a gaming device.

Referring to FIG. 1, device 100 includes, but not limited to, processor 101 coupled to random-access memory (RAM) 102 and storage device 103. Processor 101 may be any kind of microprocessors, which may represent a single processor, multiple processors, or multiple processor cores, collectively referred to as a central processing unit (CPU). RAM 102 may be any kind of volatile memory devices, such as double-data rate (DDR) memory (e.g., DDR-2, DDR-3). RAM 102 may be utilized by processor 101 to execute any executable components, such as an operating system (OS) or file system. An operating system may be any kind of operating systems, such as Windows™ operating system from Microsoft Corporation of Redmond, Wash., Mac OS™ or iOS™ from Apple Inc. of Cupertino, Calif., or a LINUX operating system.

Storage device 103 may be any kind of non-volatile memory devices, such as hard drives or flash memory devices (e.g., NOR or NAND type flash memory). Storage device 103 may be partitioned into multiple partitions (also referred to as volumes) such as system volume 108, data volume 109, and update volume 110. Each of the volumes 108-110 may be configured via their respective partition entries of partition table 111, which is mapped to chunks of physical storage media via chunk mapping table 112. Volumes 108-110 may be managed and configured by volume manager 107 executed in RAM 102, which may be implemented as part of an operating system or storage system software/firmware.

A system volume refers to a storage volume that contains the hardware-specific files that are needed to start an operating system. The system volume may be a primary volume that is marked as active. This requirement can be fulfilled on any drive on the device that a system boot loader searches when the operating system starts. System volume 108 may be used to store certain executable code images representing certain system components (e.g., OS components) of computing device 100. Data volume 109 may be used to store any user related applications and/or data, which may be encrypted by storage key 105. Storage key 105 may be derived from a UID that uniquely represents computing device 100. Data volume 109 may represent multiple data volumes, each represented by an identifier such as a global unique identifier (GUID). Content of each data volume may be encrypted by a specific partition encryption key, where the partition encryption key may be stored in a blob along with its corresponding partition ID and the blob is wrapped by storage key 105 and stored in a secured storage location, such as system volume 108.

In one embodiment, computing device 100 further includes a software update module 106 executed in RAM 102, which is responsible for updating components (e.g., system components) of computing device 100. Software update module 106 may be a part of an operating system or standard system component of computing device 100. When there is a need to update a software component of computing device 100, software update module 106 communicates with volume manager 107 to create a specific storage area for update purposes. In response, volume manager 107 creates update volume 110 to store a software update image downloaded by software update module 106 from remote server 130 over network 120, which may be a local area network and/or a wide area network (e.g., Internet). As a result, the software update image can be downloaded and stored in update volume 110, separately and/or isolated from existing components and data stored in system volume 108 and data volume 109, to reduce the chances of contaminating content of system volume 108 and data volume 109 by the software update. Prior to storing the software update image in update volume 110, the software update image may be authenticated by software update module 106, including verifying a digital certificate used to sign the software update image to ensure that the software update image is received from a trusted server and/or matching an ID extracted from the software update image against the UID of computing device 100 to ensure that the software image is specifically created for computing device 100.

Once the software update has been downloaded and stored in update volume 110, according to one embodiment, computing device 100 reboots from update volume 110, for example, by boot loader 104. One of the purposes of rebooting from update volume 110 is to prevent any virus or other unwanted malware from contaminating system volume 108 and data volume 109. Whatever being executed from update volume 110 is limited (e.g., sandboxed) within an operating environment and resources associated with update volume 110 until it has been successfully authenticated and verified.

In one embodiment, prior to installing the software update, system volume 108 is examined, for example, by software update module 106, to determine whether system volume 108 is suitable for installing the software update. If it is determined that system volume 108 is not suitable for installing the software update, the size of system volume 108 may be dynamically adjusted. For example, given a current size of system volume 108, if it is determined that after the installation system volume 108 would not be able to store all of the components in the new operating environment, the size of system volume 108 may be increased. On the other hand, if it is determined that the size of the current system volume is larger than what it is needed, the size of system volume 108 may be reduced for other usages (e.g., reallocated to data volume 109).

According to one embodiment, system volume 108 can be dynamically resized by reconfiguring partition table 111 and chunk mapping table 112, without having to move or copy the underlying data chunks. The encrypted content stored in data volume 109 can remain encrypted. In one embodiment, to increase the size of system volume 108, unused chunks that have been mapped to data volume 109 can be remapped to system volume 108 by modifying the corresponding chunk map entries (CMEs) of chunk mapping table 112, without having to relocate or copy existing content stored in data volume 109. Similarly, to reduce the size of system volume 108, the unused chunks of system volume 108 can be remapped back to data volume 109 via chunk mapping table 112. The chunks to be remapped may be those at the end of a partition.

Once the system volume 108 has been resized, components of the software update can be extracted, authenticated, and installed into system volume 108 from update volume 110. The update components may be authenticated using a digital certificate stored in a secure read-only memory (ROM) (not shown) associated with processor 101 or other secure storage locations, to ensure that the software update is received from a trusted source. In addition, an ID may be extracted from the software update may be matched with the UID of computing device to ensure that the software update is intended for computing device. Note that if the software update has been authenticated prior to being stored in update volume 110, this authentication process may be skipped. Furthermore, at least some of the update components may be decrypted using key 105, which is derived from a UID of computing device 100. Once all components of the software update have been installed in system volume 108, computing device 100 may reboot into system volume 108. Thereafter, update volume 110 may be optionally deleted, for example, by modifying partition table 111 and chunk mapping table 112.

During the reboot, initially, boot loader 104 is executed, for example, from a secure ROM of processor 101, which locates the boot code from system volume 108 and authenticates and/or verifies the boot code. In one embodiment, some of the components being loaded from system volume 108 may be signed by a certificate. Boot loader 104 is configured to authenticate the boot code using a digital certificate such as X.509 compatible certificates (not shown). If the boot code cannot be successfully authenticated, computing device 100 may be forced into a recovery mode (e.g., device firmware update or DFU mode) in which new data may be provisioned and downloaded from a trusted server such as server 130. Once the boot code has been authenticated successfully, it is launched by boot loader 104 within RAM 102 to establish an operating environment (e.g., OS and/or file system) for processor 101.

The boot code may include multiple segments and each of the segments may be signed by one of a chain of certificates such as X.509 chain of certificates. A digital certificate, for example, stored in the secure ROM of processor 101, may be used to authenticate the first overall code segment. In one embodiment, segments of the boot code are configured as a sequence of segments. A current segment of the code sequence may authenticate a next segment of the code sequence using the chain of certificates. For example, segments of the code may include a low level boot code, an intermediate level boot code, and a high level boot code. The low level boot code may be authenticated first by the root certificate (e.g., stored in the secure ROM). Once the low level boot code has been authenticated or verified, the low level boot code may be launched or executed. Once the low level boot is running, the low level boot code may (fetch and) authenticate the intermediate level boot code, which in turn upon having been successfully authenticated and loaded by the low level boot code, may (fetch and) authenticate the high level boot code, and so on. If there is any segment of software components that cannot be successfully authenticated and executed, the device may be forced into a DFU mode, in which a new version of the software may be downloaded from a trusted server.

In addition, according to one embodiment, the code image and/or data may be encrypted by a key derived from a UID that uniquely identifies the processor 101. That is, the code image and/or data may be personalized by encrypting the same using a key derived from the UID. As a result, only the software components that are specifically configured or provisioned for device 100 can be allowed to be installed on device 100. The UID may also be stored in a secured location such as a secure ROM of processor 101. Alternatively, the UID may be hardwired (e.g., via burnt fuses) on the hardware (e.g., chipset or motherboard) associated with processor 101. As a result, each software component is authenticated and recovered before being executed to ensure that the software components have not been compromised. Further detailed information concerning the authentication and booting of software components in order to establish an operating environment for a processor can be found in co-pending U.S. patent application Ser. No. 11/620,689, entitled “Secure Booting A Computing Device,” filed Jan. 7, 2007, which is incorporated by reference herein in its entirety.

Further, some of the code images and/or data may be packaged according to a predetermined format and can be authenticated via a common security model. For example, some of the code images and/or data may be packaged similar to an Image3 format. In such an implementation, each of the software components to be installed and loaded in the system is implemented or packaged as an object having a predetermined format such that a single security processing engine (e.g., code builder and/or code loader) can be used to build and verify each of the objects as a mechanism to determine whether each software component is trusted and compatible with certain limitations or criteria of the system before executing the executable code embedded within the respective object. At least a portion of each object, such as a payload of the object, may be encrypted by a key that is derived from the UID of the device (e.g., licked or personalized), in which only the targeted device can decrypt the object. Further detailed information concerning the Image3 format and/or the common security model can be found in co-pending U.S. patent application Ser. No. 12/103,685, entitled “Single Security Model in Booting a Computing Device,” filed Apr. 15, 2008, which is incorporated by reference herein in its entirety.

Furthermore, according to one embodiment, some of the software updates may be packaged and distributed using a ticket-based authorization process for secure installation. In this embodiment, the software updates may be specifically packaged and personalized via a “ticket.” A ticket represents a collection of security measures such as hashes and/or version identifiers for each of the software components. A ticket may be generated and distributed by a central authority such as authorization server 130. A ticket may reduce the chances that a hacker can mix and match different versions of the software components for installation. Further detailed information concerning the ticket-based authorization process can be found in co-pending U.S. patent application Ser. No. 12/329,377, entitled “Ticket Authorized Secure Installation and Boot,” filed Dec. 5, 2008, which is incorporated by reference herein in its entirety.

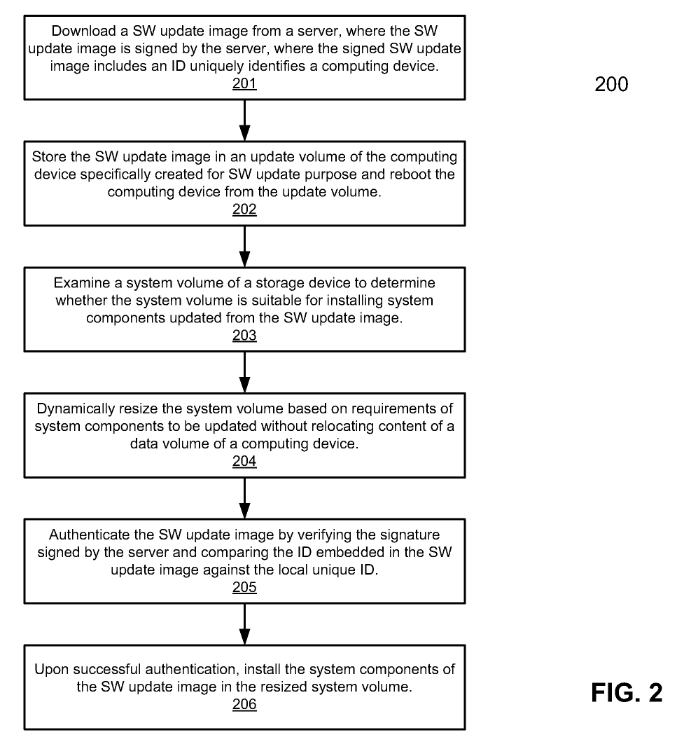

FIG. 2 is a flow diagram illustrating a method for software update according to one embodiment of the invention. For example, method 200 may be performed by software update module 106 and volume manager 107 of FIG. 1. Referring to FIG. 2, at block 201, a software update image is downloaded from a server, where the software update image is signed by the server using a digital certificate. The software update image may further include an ID that uniquely identifies a computing device, where the ID may or may not be encrypted within the software update image. At block 202, the software update image is stored in an update volume of a storage device of the computing device that is specifically created for software update purpose, and the computing device reboots into the update volume. At block 203, the system volume of the storage device is examined to determine whether the system volume is suitable for installing system components of the software update. At block 204, the system volume is dynamically resized based on the determination without having to relocating content of a data volume of the storage device. At block 205, the system components of the software update are authenticated including verifying the digital certificate and/or matching the ID with the UID of the device. Note that the authentication process may also be performed prior to storing the software update image in the device. Thereafter, at block 206, the software update is installed in the resized system volume.

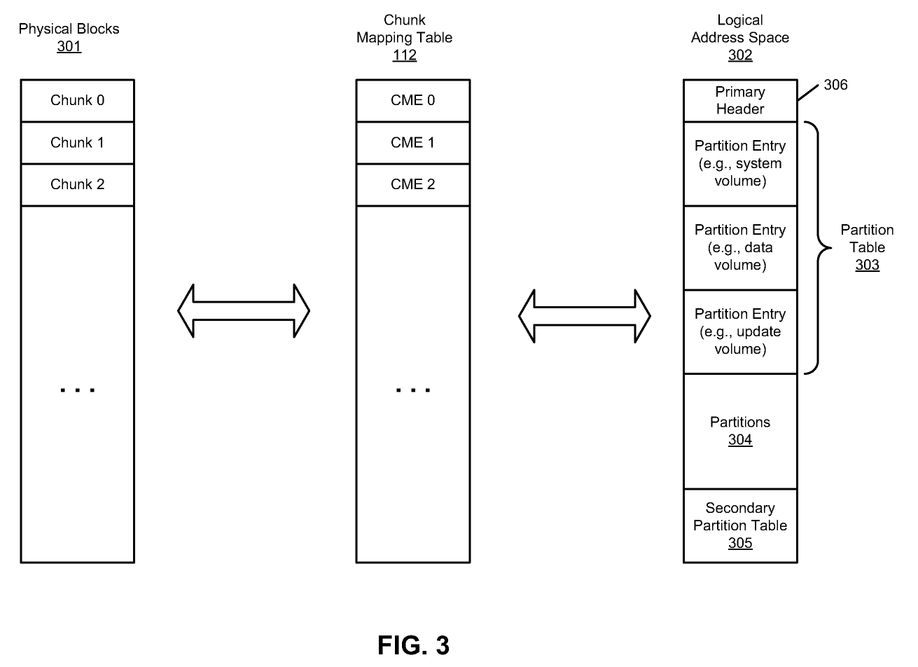

FIG. 3 is a block diagram illustrating a chunk mapping mechanism according to one embodiment of the invention. Referring to FIG. 3, physical storage media 301 of storage device 103 typically is configured in a form of physical chunks (also referred to as physical blocks) with a fixed size (e.g., 1024 bytes). For each chunk there is a corresponding CME in chunk mapping table 112 to map the corresponding chunk to one of the partitions of logical space 302 such as system partition and data partition, etc. Partition table 111 may be any kind of partitions that configure one or more partitions in the logical space, which is accessed based on logical block addressing (LBA).

Logical space 302 typically includes a primary partition table 303 and secondary partition table 305, and the actual partitions 304 in between. In one embodiment, partition table 304 is a GUID partition table (GPT), which is a standard for the layout of the partition table on a physical storage media. In a GPT, partition table information is stored in the GPT header 306, but to maintain compatibility, GPT retains the master boot record (MBR) entry as the first sector on the storage media. Partition table header 306 defines the usable blocks on the storage media. It also defines the number and size of the partition entries that make up the partition table. Header 306 contains a GUID that identifies the corresponding storage media or storage device. It records its own size and location and the size and location of the secondary header and table (typically the last sectors on the media). It also contains a cyclic redundancy check (CRC) such as CRC32 checksum for itself and for partition table 303, which may be verified by the firmware, boot loader, and/or operating system on boot. As a result, the header is typically not for edit because such modification would render the checksum invalid. Header 306 may be stored in a predetermined physical location such as the first physical chunk (e.g., chunk 0). According to one embodiment, a write to header 306 may be interpreted as a write request to edit partition table 303 instead, for the purpose of resizing a particular partition.

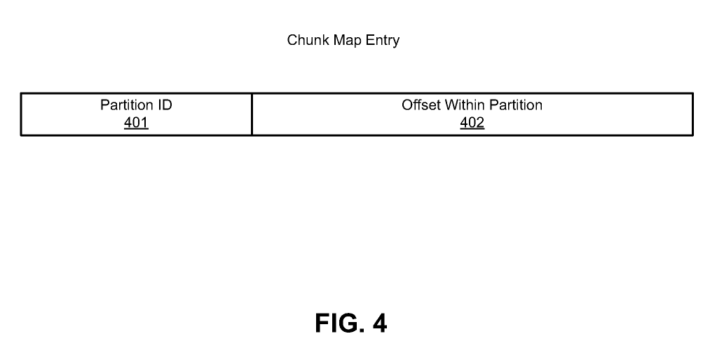

Partition table 303 includes one or more partition entries, each corresponding to a particular partition (e.g., system volume, data volume, or update volume). Each partition entry includes a first ID identifying a type of partition, a second ID uniquely identifying the corresponding partition, a start/first LBA address, and an end/last LBA address of the partition. In one embodiment, as shown in FIG. 4, CME 400 of chunk mapping table 112 includes a first field 401 for specifying a partition ID (e.g., GUID) of a partition to be mapped and a second field 402 for specifying an offset within the mapped partition at which the corresponding chunk is mapped.

Chunk mapping table 112 assigns chunks of the physical blocks to partition table entries. According to one embodiment, a chunk can be uniquely assigned to an offset in a partition using a CME having a predetermined number of bits such as 16 bits. In one embodiment, the lower (e.g., least significant) 10 bits of the CME provides the offset of the chunk within the partition and the top (e.g., most significant) 4 bits identify the partition (e.g., partition GUID) to which the chunk belongs. A partition ID of a predetermined value such as 0xF can be used to indicate the chunks that are not currently assigned to any partition, either because they are free or reserved. In one embodiment, chunk mapping table 112 is stored within header 306 or other predetermined locations.

Referring to FIGS. 3 and 4, according to one embodiment, when resizing a first partition (e.g., system partition or volume), instead of relocating existing data of a second partition (e.g., data partition or volume) to make rooms for the first partition, one or more unused or unclaimed chunks of the second partition may be remapped by modifying the partition ID and offset of the corresponding one or more CMEs to map the one or more unused chunks to the first partition. In one embodiment, chunks are assigned to partitions in an ordered list. In one embodiment, chunks may be added to or removed from the end of a partition. Thus, no part of a partition that contains data ever moves—it always stays in the same chunk. Therefore, since the existing data of the second partition is not moved, those data can be accessed as usual and may be concurrently accessed while the resizing is being performed. Similarly, if the data of the second partition is encrypted, the content can remain encrypted during the resizing. Such resizing can be performed transparently without user intervention and/or acknowledge.

As described above, partitions may be moved, resized, added or deleted by the GPT update, which may be initiated by the software update (e.g., software update module 106 and performed by volume manager 107 of FIG. 1). In one embodiment, in order to reconfigure a partition, a write request may be issued to a predetermined location of the logical space, such as, for example, header 306 of logical space 302. Typically, header 306 is not allowed for modification. By issuing a write request to header 306, such a write request may be interpreted, for example, by the volume manager, for the purpose of reconfiguring the partitions. In one embodiment, partitions in the new partition table (e.g., extracted from the request) are matched (e.g., by a volume manager) against partitions in the existing partition table, for example, by comparing the partition IDs. Partitions whose IDs of the existing partition table are not present in the new partition table may be deleted from the existing partition table. Partitions whose IDs are new in the update may be created in the existing partition table using the unused chunks and mapped via the chunk mapping table. Partitions whose IDs are present in both partition tables may have their size (e.g., start and end LDA addresses) updated to suit the new partition table.

According to some embodiments, keys for some or all encrypted partitions may be stored along with their respective partition IDs in a blob that is wrapped with a storage key (e.g., storage key 105 of FIG. 1), which may be derived from a UID of a computing device. When the partition configuration changes, the blob may also be erased and/or modified. In the event of a race between writing the new keys and updating the header, partitions that have been deleted will have their keys destroyed, but partitions being preserved will not be at risk of data loss. To instantly erase the contents of an encrypted partition, the partition table can be rewritten with a new partition ID assigned to the partition. This will cause a key to be erased and a new key issued, effectively destroying the data associated with the partition.

According to one embodiment, in response to writes into the GPT area the configuration changes are buffered without processing them until an operation attempts to read, or to write outside the GPT area. This avoids a problem where the GPT is updated in several separate writes, and the intermediate state of the GPT may be invalid. Further, if the configuration update fails due to the updated GPT being invalid, the configuration change is rejected and read/write operations are temporarily refused for any part of the exported media other than the GPT. Once the VM believes that writes to the GPT are finished (because a new operation is a read or is a write addressing some part of the media that is not the GPT), the VM analyzes its buffered copy of the GPT that has been written.

The configuration lock is then acquired which is used to block any read/write or reconfiguration operations. The GPT signature is then verified, where the GPT signature may be stored within the GPT header, such as MBR of the GPT header. The GPT location field and partition table entry size fields are examined to ensure they are consistent with the VM's expectations. The list of partitions in the GPT may be trimmed or adjust, as the VM may only support a predetermined number of partitions, but GPT may declare more otherwise. In one embodiment, each partition entry is examined for consistency. For example, entries are required to specify an ending address greater than their starting address. They should not fall outside the boundaries of the logical blocks. Their UUIDs must be unique and they must not overlap any other partition.

A new VM header structure is then created to contain the new configuration. Partitions that exist in both the old and the new configuration are copied to the new header structure. Partitions are identified by their UUIDs. A partition having the same UUID in both the old and new configurations is considered to be the same partition. If there is encryption information for the partition, it is also copied. This copying includes copying chunk allocation information. Partitions that exist in the new configuration but do not exist in the old configuration are created in the new header. If the partition is to be encrypted, new keying material is generated.

In one embodiment, chunk allocations for partitions are adjusted in two stages. In the first phase, partitions that have been copied but which have shrunk have more chunks assigned than required; these chunks are marked as free in the new header. In the second phase, chunks are assigned to new partitions or to partitions which have grown. Thereafter, the new header is sanity-checked. Keying material for the new header is committed to effaceable storage. The ordering of this commit before the header commit ensures that partitions that are being destroyed lose their keying material, even if the operation is interrupted and the new header is blocked from being written.

Further, new partitions' keying material is guaranteed to be present before the new partitions come into existence. The new header is written to the predetermined location (e.g., chunk 0). The primary copy is written first, then the backup copy. “Discard” operations are issued for chunks which are not assigned to parts of an existing partition. This operation is the same as an ATA “TRIM” command, and it provides a NAND-based storage layer the opportunity to optimize its garbage collection by not treating the contents of these chunks as precious. The new header is processed to generate new internal partition structures. Finally, the configuration lock is released to allow others accessing the partition tables or partitions.

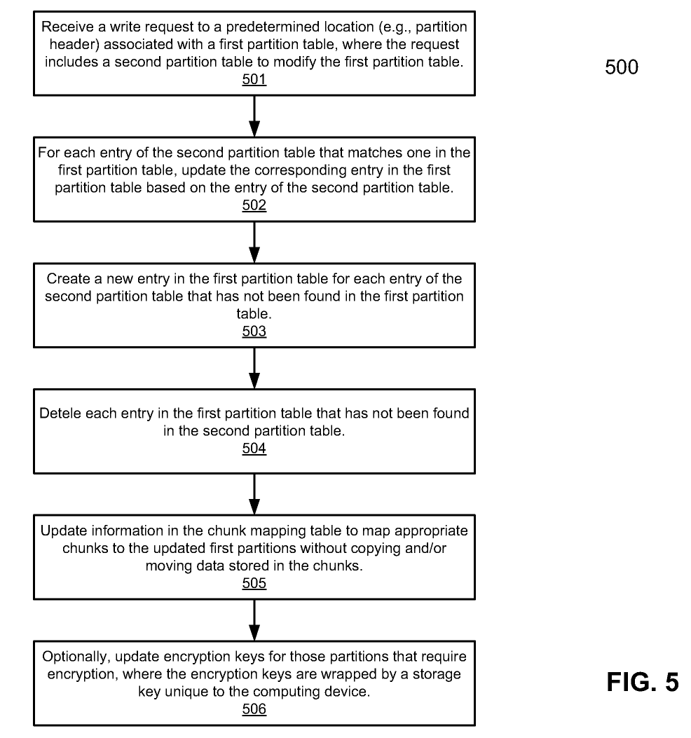

FIG. 5 is a flow diagram illustrating a method resizing a partition according to one embodiment of the invention. For example, method 500 may be performed by volume manager 107 of FIG. 1. Referring to FIG. 5, at block 501, a write request is received for writing to a predetermined location (e.g., partition header) within a first partition table (e.g., existing partition table), where the request includes a second partition table (e.g., a new partition table) to modify the first partition table. At block 502, for each partition entry of the second partition table that matches one in the first partition table, update the corresponding entry in the first partition table based on the information of the second partition table. At block 503, a new partition entry is created in the first partition table for each entry of the second partition table that has not been found in the first partition table, and to replicate the entry from the second partition table in the new partition entry. At block 504, each partition entry in the first partition table that has not been found in the second partition table is deleted. At block 505, a chunk mapping table is updated to map appropriate chunks to the updated first partition table without having to relocate and/or copy the content of the existing chunks. At block 506, encryption keys are optionally updated for those partitions that require encryption, where the encryption keys are wrapped by a storage key unique to the computing device.

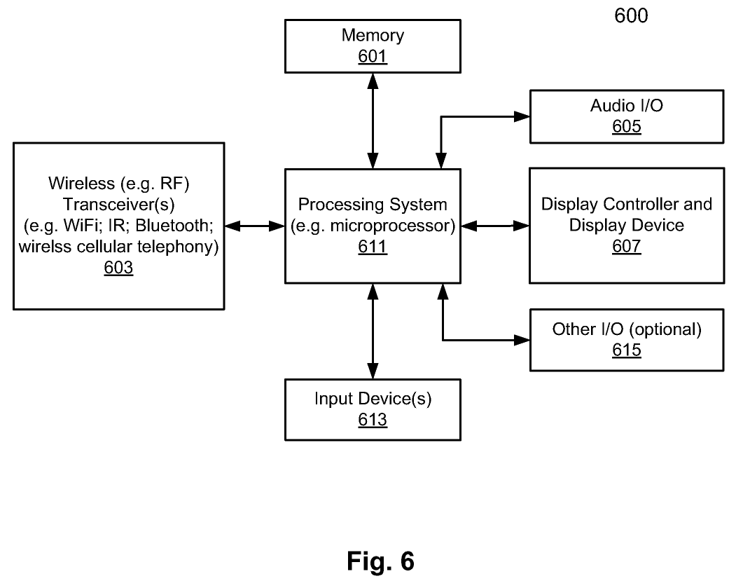

FIG. 6 shows an example of a data processing system which may be used with one embodiment of the present invention. For example, system 600 may be implemented as device 100 as shown in FIG. 1. The data processing system 600 shown in FIG. 6 includes a processing system 611, which may be one or more microprocessors, or which may be a system on a chip of integrated circuit, and the system also includes memory 601 for storing data and programs for execution by the processing system. The system 600 also includes an audio input/output subsystem 605 which may include a microphone and a speaker for, for example, playing back music or providing telephone functionality through the speaker and microphone.

A display controller and display device 607 provide a visual user interface for the user; this digital interface may include a graphical user interface which is similar to that shown on an iPhone® phone device, an iPad® device, or on a Macintosh computer when running operating system software. The system 600 also optionally includes one or more wireless transceivers 603 to communicate with another data processing system. A wireless transceiver may be a WiFi transceiver, an infrared transceiver, a Bluetooth transceiver, and/or a wireless cellular telephony transceiver. It will be appreciated that additional components, not shown, may also be part of the system 600 in certain embodiments, and in certain embodiments fewer components than shown in FIG. 6 may also be used in a data processing system.

The data processing system 600 also includes one or more input devices 613 which are provided to allow a user to provide input to the system. These input devices may be a keypad, a keyboard, a touch panel, or a multi touch panel. The data processing system 600 also includes an optional input/output device 615 which may be a connector for a dock. It will be appreciated that one or more buses, not shown, may be used to interconnect the various components as is well known in the art. The data processing system shown in FIG. 6 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device. In other embodiments, the data processing system 600 may be a network computer or an embedded processing device within another device, or other types of data processing systems which have fewer components or perhaps more components than that shown in FIG. 6.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod®, or iPod Nano® media player from Apple Inc. of Cupertino, Calif., a touch screen or multi-touch input device, pushbutton device, movable pointing input device or other input device. The media selection device may be used to select the media stored on the storage device and/or a remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s).

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for updating system components of a computing device, the method comprising:
receiving, by a software updater, a software update image from a server over a network to update one or more system components of a computing device, the software update image being signed by the server using a digital certificate and the software update image including an identifier (ID) that uniquely identifies the computing device;
storing, by the software updater, the software update image in an update volume specifically created for update purposes in a storage device of the computing device, the storage device including a system volume having system components stored therein and a data volume having user data stored therein;
rebooting the computing device into the update volume without using the system volume;
dynamically resizing, by a volume manager, the system volume based on a requirement of the one or more system components to be updated without physically relocating data stored in the data volume of the storage device;
authenticating the software update image including verifying the digital certificate to ensure that the software update image is received from a trusted source and matching the ID of the software update image against a unique ID (UID) embedded within the computing device to ensure that the software update image is intended for the computing device; and
installing the one or more system components from the software update image from the update volume into the resized system volume upon successful authentication.

2. The method of claim 1, wherein resizing the system volume comprises:
maintaining a chunk mapping table having a plurality of chunk map entries (CMEs), each CME mapping a physical chunk of a physical storage media of the storage device to one of a plurality of partition entries of a partition table, including a system partition table associated with the system volume and a data partition table associated with the data volume;
modifying one or more CMEs of the chunk mapping table to remap one or more chunks of the physical storage media to the system partition entry; and
updating start and end logical addresses of the system partition entry based on the remapped one or more chunks.

3. The method of claim 2, wherein modifying one or more CMEs of the chunk mapping table comprises:
remapping the one or more chunks of the physical storage media from the data volume that have not been claimed to the system volume to increase a size of the system volume without having to relocate data stored in the data volume; and
updating start and end logical addresses of the data partition entry in view of the remapped one or more chunks.

4. The method of claim 3, wherein the partition table is a global unique identifier (GUID) partition table (GPT), and wherein the system partition entry is identified by a system partition GUID and the data partition entry is identified by a data partition GUID.

5. The method of claim 4, wherein each CME of the chunk mapping table comprises a first field for specifying a GUID identifying a partition entry being mapped and a second field for specifying a location within a logical space of a partition associated with the identified partition entry, within which the corresponding chunk is mapped.

6. The method of claim 5, wherein remapping the one or more chunks from the data partition to the system partition comprises modifying the first field of corresponding CMEs to include the system partition GUID and modifying the second field of the corresponding CMEs to specify an offset from a start logical address of the system partition.

7. The method of claim 4, further comprising:
encrypting content stored in the data partition using an encryption key;
storing the encryption key identified by the data partition GUID in a blob; and
wrapping the blob with a storage key that is derived from the UID of the computing device, wherein the one or more chunks are remapped without having to decrypt the content of the data partition.

8. The method of claim 1, further comprising:
rebooting the computing device into the resized system volume after the software update image has been installed;
executing a boot loader from a secure read-only memory (ROM) of the computing device;
authenticating, by the boot loader, a first boot code segment of the system volume using a digital certificate stored in the secure ROM, wherein the digital certificate is a part of chain of certificates;
launching, by the boot loader, the first boot code segment upon successfully authenticating the first boot code segment;
authenticating, by the first boot code segment, a second boot code segment, using a leaf derived from the chain of certificate; and
launching, by the first boot code segment, the second boot code segment upon successfully authenticating the second boot code segment.

9. A machine-readable storage medium having instructions stored therein, which when executed by a machine, cause the machine to perform a method for updating system components of a computing device, the method comprising:
receiving, by a software updater, a software update image from a server over a network to update one or more system components of a computing device, the software update image being signed by the server using a digital certificate and the software update image including an identifier (ID) that uniquely identifies the computing device;
storing, by the software updater, the software update image in an update volume specifically created for update purposes in a storage device of the computing device, the storage device including a system volume having system components stored therein and a data volume having user data stored therein;
rebooting the computing device into the update volume without using the system volume;
dynamically resizing, by a volume manager, the system volume based on a requirement of the one or more system components to be updated without physically relocating data stored in the data volume of the storage device;
authenticating the software update image including verifying the digital certificate to ensure that the software update image is received from a trusted source and matching the ID of the software update image against a unique ID (UID) embedded within the computing device to ensure that the software update image is intended for the computing device; and
installing the one or more system components from the software update image from the update volume into the resized system volume upon successful authentication.

10. The machine-readable storage medium of claim 9, wherein resizing the system volume comprises:
maintaining a chunk mapping table having a plurality of chunk map entries (CMEs), each CME mapping a physical chunk of a physical storage media of the storage device to one of a plurality of partition entries of a partition table, including a system partition table associated with the system volume and a data partition table associated with the data volume;
modifying one or more CMEs of the chunk mapping table to remap one or more chunks of the physical storage media to the system partition entry; and
updating start and end logical addresses of the system partition entry based on the remapped one or more chunks.

11. The machine-readable storage medium of claim 10, wherein modifying one or more CMEs of the chunk mapping table comprises:
remapping the one or more chunks of the physical storage media from the data volume that have not been claimed to the system volume to increase a size of the system volume without having to relocate data stored in the data volume; and
updating start and end logical addresses of the data partition entry in view of the remapped one or more chunks.

12. The machine-readable storage medium of claim 11, wherein the partition table is a global unique identifier (GUID) partition table (GPT), and wherein the system partition entry is identified by a system partition GUID and the data partition entry is identified by a data partition GUID.

13. The machine-readable storage medium of claim 12, wherein each CME of the chunk mapping table comprises a first field for specifying a GUID identifying a partition entry being mapped and a second field for specifying a location within a logical space of a partition associated with the identified partition entry, within which the corresponding chunk is mapped.

14. The machine-readable storage medium of claim 13, wherein remapping the one or more chunks from the data partition to the system partition comprises modifying the first field of corresponding CMEs to include the system partition GUID and modifying the second field of the corresponding CMEs to specify an offset from a start logical address of the system partition.

15. The machine-readable storage medium of claim 12, wherein the method further comprises:
encrypting content stored in the data partition using an encryption key;
storing the encryption key identified by the data partition GUID in a blob; and
wrapping the blob with a storage key that is derived from the UID of the computing device, wherein the one or more chunks are remapped without having to decrypt the content of the data partition.

16. The machine-readable storage medium of claim 9, wherein the method further comprises:
rebooting the computing device into the resized system volume after the software update image has been installed;
executing a boot loader from a secure read-only memory (ROM) of the computing device;
authenticating, by the boot loader, a first boot code segment of the system volume using a digital certificate stored in the secure ROM, wherein the digital certificate is a part of chain of certificates;
launching, by the boot loader, the first boot code segment upon successfully authenticating the first boot code segment;
authenticating, by the first boot code segment, a second boot code segment, using a leaf derived from the chain of certificate; and
launching, by the first boot code segment, the second boot code segment upon successfully authenticating the second boot code segment.

17. A computing device, comprising:
a processor;
a storage device; and
a memory coupled to the processor to store instructions, which when executed by the processor, cause the processor to
receive a software update image from a server over a network to update one or more system components of a computing device, the software update image being signed by the server using a digital certificate and the software update image including an identifier (ID) that uniquely identifies the computing device,
store the software update image in an update volume specifically created for update purposes in a storage device of the computing device, the storage device including a system volume having system components stored therein and a data volume having user data stored therein,
reboot the computing device into the update volume without using the system volume,
dynamically resize the system volume based on a requirement of the one or more system components to be updated without physically relocating data stored in the data volume of the storage device,
authenticate the software update image including verifying the digital certificate to ensure that the software update image is received from a trusted source and matching the ID of the software update image against a unique ID (UID) embedded within the computing device to ensure that the software update image is intended for the computing device, and
install the one or more system components from the software update image from the update volume into the resized system volume upon successful authentication.

18. The device of claim 17, wherein resizing the system volume comprises:
maintaining a chunk mapping table having a plurality of chunk map entries (CMEs), each CME mapping a physical chunk of a physical storage media of the storage device to one of a plurality of partition entries of a partition table, including a system partition table associated with the system volume and a data partition table associated with the data volume;
modifying one or more CMEs of the chunk mapping table to remap one or more chunks of the physical storage media to the system partition entry; and
updating start and end logical addresses of the system partition entry based on the remapped one or more chunks.

19. The device of claim 18, wherein modifying one or more CMEs of the chunk mapping table comprises:
remapping the one or more chunks of the physical storage media from the data volume that have not been claimed to the system volume to increase a size of the system volume without having to relocate data stored in the data volume; and
updating start and end logical addresses of the data partition entry in view of the remapped one or more chunks.

20. The device of claim 19, wherein the partition table is a global unique identifier (GUID) partition table (GPT), and wherein the system partition entry is identified by a system partition GUID and the data partition entry is identified by a data partition GUID.

21. The device of claim 20, wherein each CME of the chunk mapping table comprises a first field for specifying a GUID identifying a partition entry being mapped and a second field for specifying a location within a logical space of a partition associated with the identified partition entry, within which the corresponding chunk is mapped.
